(19) United States
(12) Patent Application Publication
(10) Pub. No.: US 2015/0081647 A1
(43) Pub. Date: Mar. 19, 2015

(54) SERVER AND METHOD FOR UPDATING DATA OF SERVER

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventors: CHUNG-I LEE, New Taipei (TW); DE-YI XIE, Shenzhen (CN); SHUAI-JUN TAO, Shenzhen (CN); ZHI-QIANG YI, Shenzhen (CN); JUN-CHAO YAO, Shenzhen (CN)

(21) Appl. No.: 14/488,526

(22) Filed: Sep. 17, 2014

(30) Foreign Application Priority Data
Sep. 17, 2013 (CN) 201310423310.X

(51) Int. Cl. G06F 17/30

(52) U.S. Cl. CPC G06F 17/30371; G06F 17/30312; G06F 17/30899
USPC 707/687

(57) ABSTRACT

In a method for updating data of a server, the server receives a modification operation from a client device communicating with the server. Data corresponding to the modification operation is obtained, and a database of the server for storing the obtained data is determined. The server further sends a prompt to the client device for confirming a successful modification of the obtained data, and updates the obtained data to the determined database and other databases that share the obtained data with the determined database.

### CROSS-REFERENCE TO RELATED APPLICATIONS

This application claims priority to Chinese Patent Application No. 201310423310.X filed on Sep. 17, 2013, the contents of which are incorporated by reference herein.

### FIELD

Embodiments of the present disclosure relate to data updating technology, and more specifically to a server and a method for updating data of the server.

### BACKGROUND

Data is usually shared by more than one software application in a computer. When the shared data is modified by one software application, other software applications should update the shared data to their databases. However, it costs a large amount of time to update the shared data to the databases. Although updating the shared data is of generally of no interest to a user, a prompt of a successful modification is given to the user after updating the shared data. Thus, a user may have to wait a long time for confirmation of successful modification. When shared data is modified by a web application, a network interruption may occur during the long waiting time and the prompt of successful modification may thus be lost anyway.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of a server connected to a plurality of client devices.

FIG. 2 is a block diagram of one embodiment of function modules of an updating system in the server of FIG. 1

FIG. 3 illustrates a flowchart of one embodiment of a method for updating data of the server in FIG. 1.

FIG. 4 illustrates a sub-flowchart of one embodiment for updating data to databases.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

The present disclosure is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

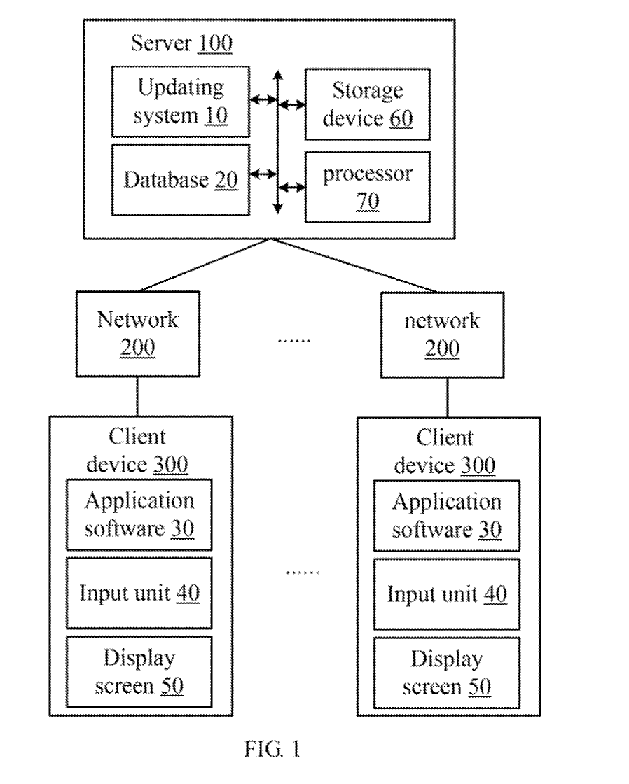

FIG. 1 illustrates a block diagram of one embodiment of a server 100 connected to a plurality of client devices 300. Depending on the embodiment, the server 100 can be a database server or a file server. The server 100 is connected to the client devices 300 through a network 200. The network 200 may be an intranet, the Internet or other communication network, such as General Packet Radio Service (GPRS), WIFI/wireless local area network (WIFI/WLAN), third generation/wideband code division multiple access (3G/WCDMA), or 3.5G/high-speed downlink packet access (3.5G/HSDPA). Each of the client devices 300 can be a tablet computer, a notebook computer, a mobile phone, or other client device.

In the embodiment, each of the client devices 300 includes, but is not limited to, one or more software applications 30 (only one software application is shown in FIG. 1), an input unit 40, and a display screen 50. The input unit 40 is configured to receive modifications by the software application 30. The display screen 50 is configured to display a prompt of successful modification to a user.

In one embodiment, the server 100 includes, but is not limited to, an updating system 10, one or more databases 20 (only one database shown in FIG. 1), a storage device 60, and at least one processor 70. Each database 20 is configured to store data of the one or more software applications 30. The server 100 is further connected to each database 20 through a database connection, such as a Java Database Connectivity (JDBC) or an Open Database Connectivity (ODBC).

In at least one embodiment, the storage device 60 can include various types of non-transitory computer-readable storage media. For example, the storage device 60 can be an internal storage system, such as a flash memory, a random access memory (RAM) for temporary storage of information, and/or a read-only memory (ROM) for permanent storage of information. The storage device 60 can also be an external storage system, such as a hard disk, a storage card, or a data storage medium. The at least one processor 70 can be a central processing unit (CPU), a microprocessor, or other data processor chip that performs functions of the server 100.

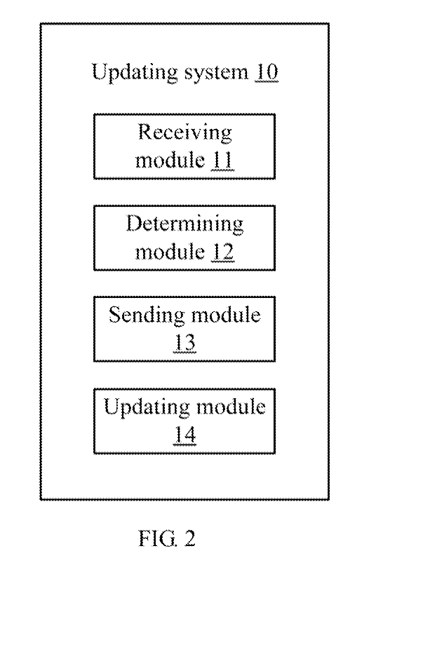

FIG. 2 is a block diagram of one embodiment of function modules of the updating system 10. In at least one embodiment, the updating system 10 can include a receiving module 11, a determining module 12, a sending module 13, and an updating module 14. The function modules 11-144 can include computerized code in the form of one or more programs, which are stored in the storage device 60. The at least one processor 70 executes the computerized code to provide functions of the function modules 11-14.

The receiving module 11 is configured to receive a modification operation in relation to a software application 30 of a client device 300 sent from the client device 300. In one embodiment, the modification operation can be an insert operation for inserting data to the software application 30, an update operation for updating data of the software application 30, or a deleting operation for deleting data of the software application 30.

The determining module 12 is configured to obtain data corresponding to the modification operation, and determine a database 20 of the server 100 for storing the obtained data. In the embodiment, the database 20 for storing the obtained data is determined by database connections of the server 100 or by a predetermined relationship between storage locations of data and the database 20.

In the embodiment, the determining module 12 further sets the obtained data to a status of pending update, and stores the obtained data in a queue in the server 100. Data in the status of pending update is stored in the queue in chronological order, and the first data set in the status of pending update is stored at the head of the queue.

The sending module 13 is configured to send a prompt to the client device 300 for confirming a successful modification of the obtained data. In the embodiment, the prompt is a prompt to only the client device 300, the obtained data is not yet updated to the determined database 20 and other databases 20 that share the obtained data with the determined database 20. Details of the obtained data updating are not displayed on the display screen 50 of the client device 300 in a predetermined time interval, for example, one second.

The updating module 14 is configured to update the obtained data to the determined database 20 and other databases 20 that share the obtained data with the determined database 20. When the obtained data is shared by more than one software application 30 and each software application 30 corresponds to one or more databases 20, the obtained data should be updated to all the relevant databases 20. For example, three software applications 30, denoted as a first software application, a second software application, and a third software application, share the obtained data. Data of the first software application is stored in a database 20 denoted as a first database, data of the second software application is stored in a database 20 denoted as a second database, and data of the third software application is stored in a database 20 denoted as a third database. When the obtained data is modified in relation to the first software application, the obtained data should be updated to the second database and the third database.

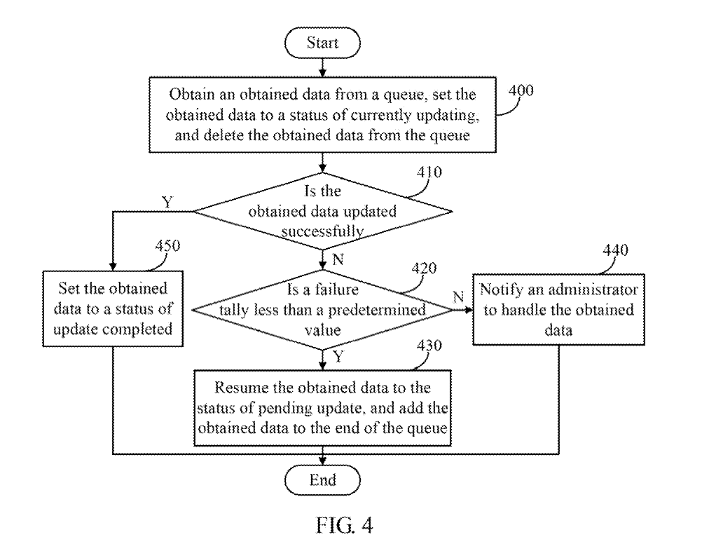

In the embodiment, the updating module 14 updates the obtained data by an update service (not shown in FIGs) stored in the server 100. The update service comprises one or more update requests, and each update request is executed by calling out and executing a stored procedure in the determined database 20 of the server 100 or by using codes and one or more structured query language statements. Details of updating the obtained data are given in FIG. 4.

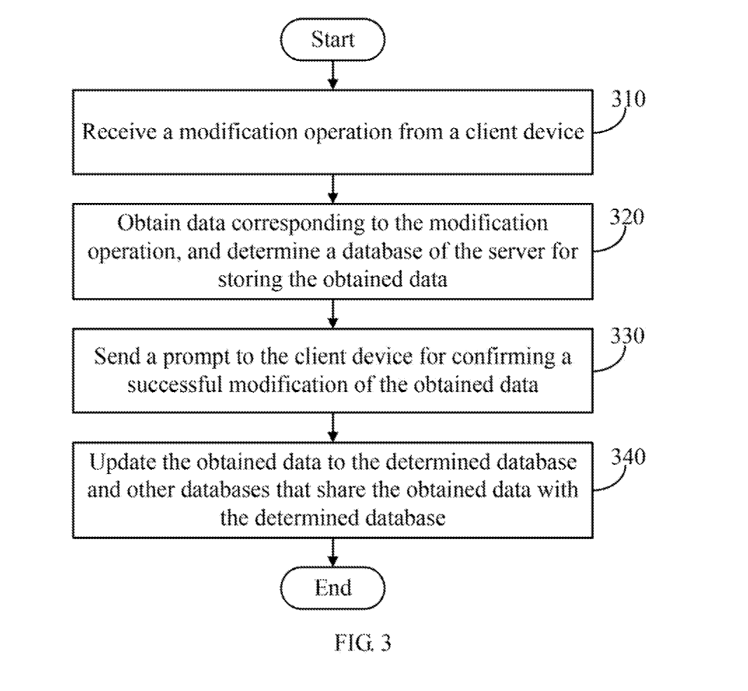

Referring to FIG. 3, a flowchart is presented in accordance with an example embodiment. The method described below can be carried out using the configurations illustrated in FIG. 1 and FIG. 2, for example, and various elements of these figures are referenced in explaining example method. Each block shown in FIG. 3 represents one or more processes, methods, or subroutines, carried out in the exemplary method. Additionally, the illustrated order of blocks is by example only and the order of the blocks can be changed. The exemplary method can begin at block 310. Depending on the embodiment, additional blocks can be added, others removed, and the ordering of the blocks can be changed.

In block 310, a receiving module receives a modification operation in relation to a software application of a client device sent from the client device.

In block 320, a determining module obtains data corresponding to the modification operation, and determines a database of the server for storing the obtained data. In the embodiment, the determining module further sets the obtained data to a status of pending update, and stores the obtained data in a queue in the server.

In block 330, a sending module sends a prompt to the client device for confirming a successful modification of the obtained data.

In block 340, an updating module updates the obtained data to the determined database and other databases that share the obtained data with the determined database. Details of updating the obtained data are given in FIG. 4.

Referring to FIG. 4, a sub-flowchart for updating the obtained data is presented in accordance with an example embodiment. The method is provided by way of example, as there are a variety of ways to carry out the method. The method described below can be carried out using the configurations illustrated in FIG. 1 and FIG. 2, for example, and various elements of these figures are referenced in explaining example method. Each block shown in FIG. 4 represents one or more processes, methods, or subroutines, carried out in the exemplary method. Additionally, the illustrated order of blocks is by example only and the order of the blocks can be changed. The exemplary method can begin at block 400. Depending on the embodiment, additional blocks can be added, others removed, and the ordering of the blocks can be changed.

In block 400, the updating module obtains the obtained data from the queue, sets the obtained data to a status of currently updating, and deletes the obtained data from the queue.

In block 410, the updating module determines whether the obtained data is updated successfully. When the obtained data is updated successfully, block 450 is executed. When the obtained data is updated unsuccessfully, block 420 is executed.

In block 420, the updating module adds one to a failure tally, and determines whether the failure tally is less than a predetermined value. When the failure tally is less than the predetermined value, block 430 is executed. When the failure tally is not less than the predetermined value, block 440 is executed. The failure tally records the number of failures to update the obtained data. The failure tally is set as zero in initial activation of the server. The predetermined value (e.g., 5) is a factory preset or preset by a user.

In block 430, the updating module resumes the obtained data to the status of pending update, and adds the obtained data to the end of the queue. When the obtained data is added to the queue, the obtained data can be updated again. When the updating problem is data connection timeouts, network connection failure, or network failure, updating the obtained data a number of times can resolve the problem.

In block 440, the updating module notifies an administrator of the server to handle the obtained data.

In block 450, the updating module sets the obtained data to a status of update completed. When the obtained data is set with the status of update completed, the obtained data is successfully updated.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the principles of the disclosure. All such modifications and variations are intended to be protected by the following claims.

What is claimed is:

1. A computer-implemented method for updating data of a server, the method comprising:
receiving a modification operation from a client device communicating with the server;
obtaining data corresponding to the modification operation;
determining a database of the server for storing the obtained data;
sending a prompt to the client device for confirming a successful modification of the obtained data; and
updating the obtained data to the determined database and other databases that share the obtained data with the determined database.

2. The method according to claim 1, wherein the modification operation comprises an insert operation, an update operation and a deleting operation.

3. The method according to claim 1, wherein the database of the server for storing the obtained data is determined by database connections of the server or by a predetermined relationship between storage locations of data and the database.

4. The method according to claim 1, further comprising:
setting the obtained data to a status of pending update, and storing the obtained data in a queue in the server.

5. The method according to claim 4, wherein updating the obtained data comprises:
obtaining the obtained data from the queue;
setting the obtained data to a status of currently updating;
deleting the obtained data from the queue;
setting the obtained data to a status of update completed when the obtained data is updated successfully;
adding one to a failure tally, and determining whether the failure tally is less than a predetermined value when the obtained data is updated unsuccessfully;
resuming the obtained data to the status of pending update, and adding the obtained data to the end of the queue when the failure tally is less than the predetermined value; and
notifying an administrator of the server to handle the obtained data when the failure tally is not less than the predetermined value.

6. The method according to claim 1, wherein the obtained data is updated by an update service stored in the server, wherein the update service comprises one or more update requests, and each update request is executed by calling out and executing a stored procedure in the determined database of the server or by using codes and one or more structured query language statements.

7. A server for updating data, the server comprising:
at least one processor; and
a storage device that stores one or more programs, when executed by the at least one processor, cause the at least one processor to:
receive a modification operation from a client device communicating with the server;
obtain data corresponding to the modification operation;
determine a database of the server for storing the obtained data;
send a prompt to the client device for confirming a successful modification of the obtained data; and
update the obtained data to the determined database and other databases that share the obtained data with the determined database.

8. The server according to claim 7, wherein the modification operation comprises an insert operation, an update operation and a deleting operation.

9. The server according to claim 7, wherein the database of the server for storing the obtained data is determined by database connections of the server or by a predetermined relationship between storage locations of data and the database.

10. The server according to claim 7, wherein the one or more programs further cause the at least one processor to:
set the obtained data to a status of pending update, and store the obtained data in a queue in the server.

11. The server according to claim 10, wherein updating the obtained data comprises:
obtaining the obtained data from the queue;
setting the obtained data to a status of currently updating;
deleting the obtained data from the queue;
setting the obtained data to a status of update completed when the obtained data is updated successfully;
adding one to a failure tally, and determining whether the failure tally is less than a predetermined value when the obtained data is updated unsuccessfully;
resuming the obtained data to the status of pending update, and adding the obtained data to the end of the queue when the failure tally is less than the predetermined value; and
notifying an administrator of the server to handle the obtained data when the failure tally is not less than the predetermined value.

12. The server according to claim 7, wherein the obtained data is updated by an update service stored in the server, wherein the update service comprises one or more update requests, and each update request is executed by calling out and executing a stored procedure in the determined database of the server or by using codes and one or more structured query language statements.

13. A non-transitory storage medium having stored thereon instructions that, when executed by a processor of a server, causes the processor to perform a method for updating data of the server, wherein the method comprises:
receiving a modification operation from a client device communicating with the server;
obtaining data corresponding to the modification operation;
determining a database of the server for storing the obtained data;
sending a prompt to the client device for confirming a successful modification of the obtained data; and
updating the obtained data to the determined database and other databases that share the obtained data with the determined database.

14. The non-transitory storage medium according to claim 13, wherein the modification operation comprises an insert operation, an update operation and a deleting operation.

15. The non-transitory storage medium according to claim 13, wherein the database of the server for storing the obtained data is determined by database connections of the server or by a predetermined relationship between storage locations of data and the database.

16. The non-transitory storage medium according to claim 13, wherein the method further comprises:
setting the obtained data to a status of pending update, and storing the obtained data in a queue in the server.

17. The non-transitory storage medium according to claim 16, wherein updating the obtained data comprises:
obtaining the obtained data from the queue;
setting the obtained data to a status of currently updating;
deleting the obtained data from the queue;
setting the obtained data to a status of update completed when the obtained data is updated successfully;
adding one to a failure tally, and determining whether the failure tally is less than a predetermined value when the obtained data is updated unsuccessfully;
resuming the obtained data to the status of pending update, and adding the obtained data to the end of the queue when the failure tally is less than the predetermined value; and
notifying an administrator of the server to handle the obtained data when the failure tally is not less than the predetermined value.

18. The non-transitory storage medium according to claim 13, wherein the obtained data is updated by an update service stored in the server, wherein the update service comprises one or more update requests, and each update request is executed by calling out and executing a stored procedure in the determined database of the server or by using codes and one or more structured query language statements.
